(19) United States
(12) Patent Application Publication
(10) Pub. No.: US 2006/0043727 A1
(43) Pub. Date: Mar. 2, 2006

(54) Pocket-size erasable note pad

(76) Inventor: Donald A. Brown, Deerfield Beach, FL (US)

Correspondence Address: Robert M. Downey;ROBERT M. DOWNEY, P.A., Suite 300, 601 South Federal Highway, Boca Raton, FL, 33432, US

(21) Appl. No.: 10/924,612

(22) Filed: Aug. 24, 2004

(51) Int. Cl. B42D 3/12

(52) U.S. Cl. 281/30

(57) ABSTRACT

A reusable note pad device includes a protective outer casing, including a top cover and a bottom cover. The top and bottom covers are hingedly attached to one another along an upper edge with a dual pivot hinge, allowing the top cover to swing open about an arc of approximately 360 degrees so that the top cover lies flat under the bottom cover, thereby exposing an erasable marker surface on the inside of the bottom cover. The underside of the top cover is provided with a bracket structure for holding two dry erase markers and a pocket for holding a foam eraser. The device is sized, structured and configured to fit neatly in a shirt or trouser pocket, a brief case or a purse. A holster has a belt loop for carrying the device on one's belt, as well as a ring for attaching the holster to a lanyard.

### BACKGROUND OF THE INVENTION

1. Field of the Invention

The present invention is directed to an erasable memo device and, more particularly, to a sleek, pocket-size case which hinges open to reveal an erasable dry marker surface, and wherein the case is structured to hold one or more dry erase markers and a foam eraser.

2. Discussion of the Related Art

In a wide variety of situations, such as in the workplace, home, travel, sports and leisure activities, it is desirable to have a readily available means of temporarily recording information, preserving it for later use, and then disposing of the information once it has been acted upon or is no longer needed. Examples of situations or environments wherein it is needed to temporarily record information include the following:
a. A Floor Supervisor in a factory or distribution setting having a need to make note of data such as job numbers, lot numbers, equipment I.D. numbers, distribution identification, bills of lading and other receiving data;
b. Repair Technicians having a need to record model numbers, serial numbers, part numbers or other data while working in the field;
c. Waiter/Waitresses in a restaurant taking food and drink orders from patrons;
d. Drivers having a need to safely and quickly record temporary information such as driving directions, license plate numbers of other vehicles, telephone numbers, business names, etc.;
e. Office workers;
f. Students; and
g. Grocery Shoppers

### OBJECTS AND ADVANTAGES OF THE INVENTION

In view of the foregoing, there remains a definite need for a handy, pocket-sized device which is adapted to temporarily record information, such as in the situations described above.

Accordingly, it is a primary object of the present invention to provide a compact and portable device which can be easily carried in one's shirt or pants pocket and which includes a protective case which opens to reveal an erasable writing surface and one or more erasable marker devices for writing on the surface along with an eraser for wiping the writing surface clean when the written information is no longer needed.

It is a further object of the present invention to provide a sleek, lightweight and relatively inexpensive device which can be carried in ones shirt or pants pocket, a brief case or purse, and wherein the device includes a molded plastic protective casing including a top cover and a bottom cover which hinge open to reveal an erasable writing surface which can be comfortably held in the hand for use, and further wherein the case is structured to hold one or more dry erase markers and an eraser.

It is still a further object of the present invention to provide a sleek and compact erasable memo device which includes an erasable writing surface, at least one dry erase marker and an eraser contained within a protective casing, and wherein the protective casing includes a top cover and a bottom cover hinged together to allow swinging rotating movement of the top cover about approximately 360 degrees of rotation relative to the bottom cover so that the top cover can be folded flat and neat under the bottom cover when the case is open to conveniently reveal the erasable writing surface within the bottom cover.

It is still a further object of the present invention to provide an erasable and paperless memo pad which is protectively concealed within a closeable case, wherein information written on the erasable writing surface can be protected and preserved against inadvertent erasure or loss when carried and transported.

It is still a further object of the present invention to provide a sleek pocket-sized erasable memo pad which eliminates the need of paper.

It is still a further object of the present invention to provide a sleek pocket-sized device for temporarily recording information, and wherein the device eliminates the need for costly electronics and an electric power source.

It is yet a further object of the present invention to provide a sleek pocket-sized erasable memo pad for temporarily recording information, and wherein the device is inexpensive and simple to use.

These and other objects and advantages of the present invention are more readily apparent with reference to the detailed description and drawings.

### SUMMARY OF THE INVENTION

The present invention is directed to a reusable note pad device which has a protective outer casing, including a top cover and a bottom cover. The top and bottom covers are hingedly attached to one another along an upper edge with a dual pivot hinge, allowing the top cover to swing open about an arc of approximately 360 degrees so that the top cover lies flat under the bottom cover, thereby exposing an erasable marker surface. The underside of the top cover is provided with a bracket structure for holding two dry erase markers and a pocket for holding a foam eraser. The device is sized, structured and configured to fit neatly in a shirt or trouser pocket, a brief case or a purse when closed, and comfortably in the hand when open for use. A holster is provided for carrying the device. The holster has a belt loop for carrying the device on one's belt, as well as a ring for attachment to a lanyard (e.g. chain, cord, strap, etc).

### BRIEF DESCRIPTION OF THE DRAWINGS

For a fuller understanding of the nature of the present invention, reference should be made to the following detailed description taken in conjunction with the accompanying drawings in which:

FIG. 1 is a top perspective view of the outer protective casing of the erasable note pad of the present invention, wherein the casing is shown with the top and bottom covers closed;

FIG. 2 is a top perspective view showing the protective casing of FIG. 1 opened with the top cover folded under the bottom cover to reveal an erasable writing surface within the bottom cover of the casing;

FIG. 3 is a side elevational view of the protective casing of FIG. 1 shown with the top and bottom covers in a closed position;

FIG. 4 is a side elevational view of the protective casing, as seen in FIG. 2, wherein the top cover is hinged to the fully open position below the bottom cover;

FIG. 5 is a top plan view showing the underside of the top cover of the protective casing which includes a bracket structure with channels for removably holding two dry erase markers and a pocket for holding a sponge eraser;

FIG. 6 is a cross-sectional view taken along the plane indicated by the arrow 6-6 in FIG. 3;

FIG. 7A is an isolated view, shown in partial cross-section, taken from the area indicated as 7-7 in FIG. 3, and illustrating a dual pivot hinge interconnecting the top and bottom covers of the protective casing;

FIG. 7B is an isolated elevational view, in partial section, illustrating operation of the hinge to permit swinging movement of the top cover relative to the bottom cover from the closed position shown in FIG. 7A and towards a fully open position wherein the top cover lies flat under the bottom cover, as seen in FIGS. 2 and 4;

FIG. 8 is a side elevational view of a holster which is shown partially cutaway to reveal the protective casing of the pocket-size erasable note pad contained therein;

FIG. 9 is a front elevational view of the holster; and

FIG. 10 is a rear elevational view of the holster illustrating a belt loop and a lanyard ring on the holster.

### DETAILED DESCRIPTION OF THE PREFERRED EMBODIMENTS

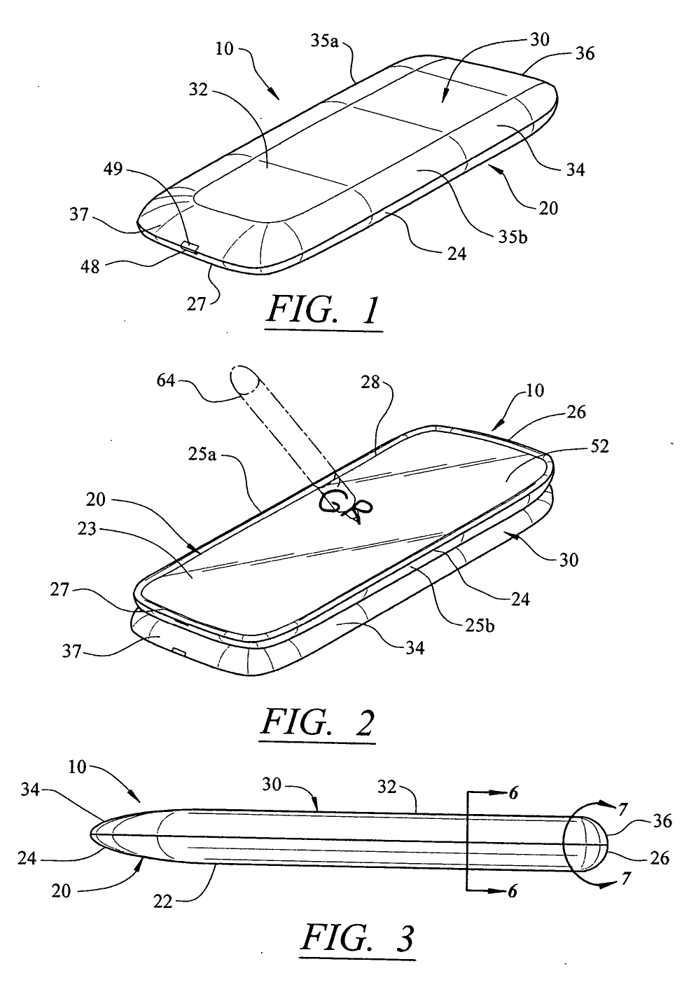

Referring to the several views of the drawings, and initially FIGS. 1-6, the pocket-size erasable note pad of the present invention is shown and is generally indicated as 10. The erasable note pad 10 is contained within a two-piece molded plastic protective outer casing 12 comprising a bottom cover 20 and a top cover 30.

The bottom cover 20 of the casing includes an exterior side 22, an inner side 23 and a tapered periphery 24. The bottom case cover 20 further includes opposite side edges 25a, 25b, an upper end 26 and a lower end 27. A rail 28 about a perimeter of the inner side 23 of the bottom case cover 20 is positioned and disposed for congruent, seated engagement with groove 38 on the top case cover when the casing 20 is closed. The mating rail 28 and groove 38 discourage shifting or sliding movement of the top and bottom covers relative to one another.

The top case cover 30 includes an exterior top side 32, an inner side 33 and a tapered periphery 34. The top case cover 30 further includes opposite side edges 35a, 35b, an upper end 36 and a lower end 37. The groove 38 about the perimeter of the inner side 33 of the top case cover 30 mates in seated engagement with the rail 28, on the bottom case cover 20 as described above.

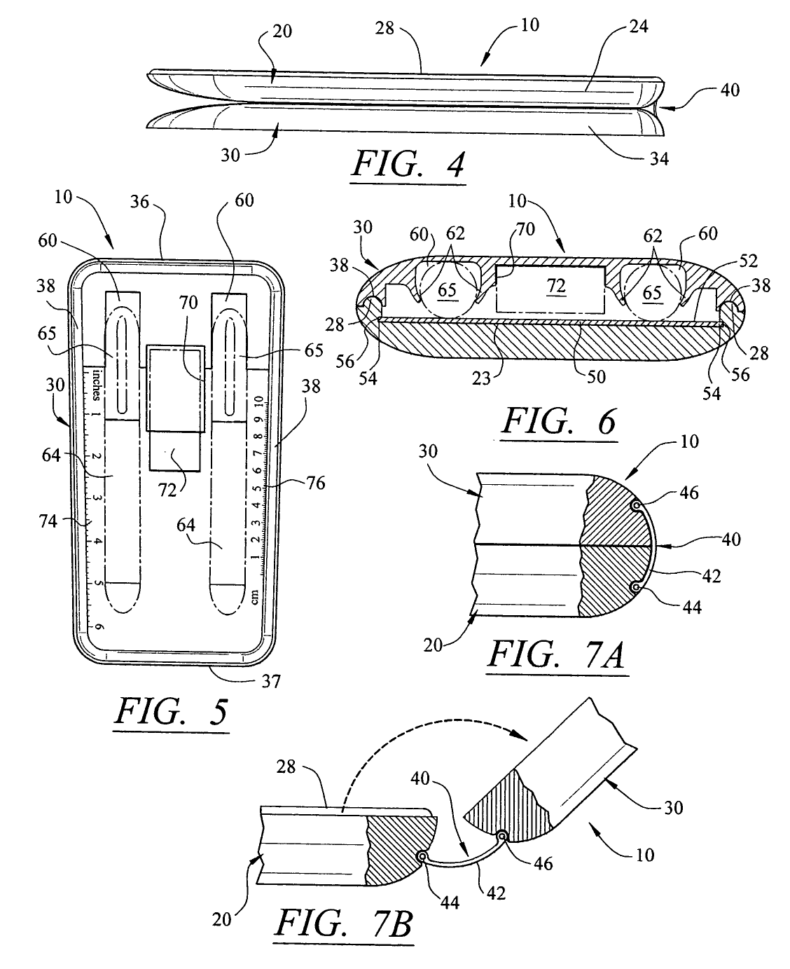

A dual pivot hinge 40 hingedly connects the top and bottom case covers 30, 20 respectively. More specifically, the dual pivot hinge 40 permits folding, hinged movement of the top case cover 30 about approximately 360 degrees of rotation relative to the bottom case cover 20 between a closed position and a fully open position, wherein the top case cover 30 is folded under the bottom case cover 20, as seen in FIGS. 2 and 4. Referring to FIGS. 7A and 7B, the dual pivot hinge 40 includes hinge member 42 pivotally connected at opposite ends to the top and bottom case covers. A first pivot axis 44 is defined at the connection of hinge member 42 to the bottom case cover 20. A second pivot axis 46 is defined at the connection of hinge member 42 to the top case cover 30. The dual pivot axis connection at both 44 and 46 allows the top case cover 30 to swing about an arc of rotation of substantially 360 degrees relative to the bottom case cover 20, as indicated by the motion of the arrow in FIG. 7B, between the closed position (FIGS. 1 and 3) and the fully open position (FIGS. 2 and 4). Locking clasps 48, 49 secure the bottom and top case covers in the closed position. To open the casing 12, the locking clasps 48, 49 are released to permit swinging, hinged movement of the top case cover 30 to the open position.

A sheet substrate 50 is fitted within the inner side 23 of the bottom case cover 20. A top exposed face of the sheet substrate 50 provides an erasable writing surface 52 for writing thereon with the use of a dry erase marker 64. In a preferred embodiment, the sheet substrate is formed of Melamine or Formica. A peripheral edge 54 of the sheet substrate 50 is fitted within slot 56 under the rail 38. The slot 56 protectively captures and conceals the surrounding peripheral edge of the sheet substrate 50 to discourage lifting, peeling or separation of the sheet substrate 50 from the inner side 23 of the bottom case cover.

The underside 33 of the top case cover 30 is molded with a bracket structure for holding dry erase markers 64 and an eraser sponge 72. More specifically, channels 60 are defined by opposing grasping members 62 molded on the underside of the top case cover 30. The grasping members 62 are specifically structured for holding a dry erase marker 64 within the respective channel 60. In a preferred embodiment, the grasping members 62 are structured and disposed for holding the caps 65 of the dry erase markers 64, permitting the dry erase markers 64 to be selectively removed from the casing 12 with the cap 65 remaining in place within the channel. This provides for convenience of removal of the markers 64 and subsequent replacement without the separate action of replacing the cap on the marker 64 prior to replacement within the channels 60. Also, retaining the caps 65 within the grasp of the grasping members 62 when the markers 64 are removed helps to prevent loss of the caps 65.

As mentioned above, the structure on the underside of the top case cover 30 provides a means for holding an eraser sponge 72. More specifically, a pocket 70 is formed on the underside of the top case cover 30. The pocket is specifically sized to removably hold an eraser sponge 72 for convenient access and removal when the user desires to erase any marked indicia on the writing surface 52.

For convenience, the inner side 33 of the top case cover 30 is provided with ruler markings along the opposite longitudinal side edges, just inboard of the groove 38. Specifically, a six inch ruler 74 is provided along one side, while a metric (centimeters) ruler 76 is provided along the opposite side, as seen in FIG. 5. The gradient lines and units of measurement on rulers 74, 76 may be provided in the form of either a two-dimensional printed indicia or, alternatively, an embossed or raised surface.

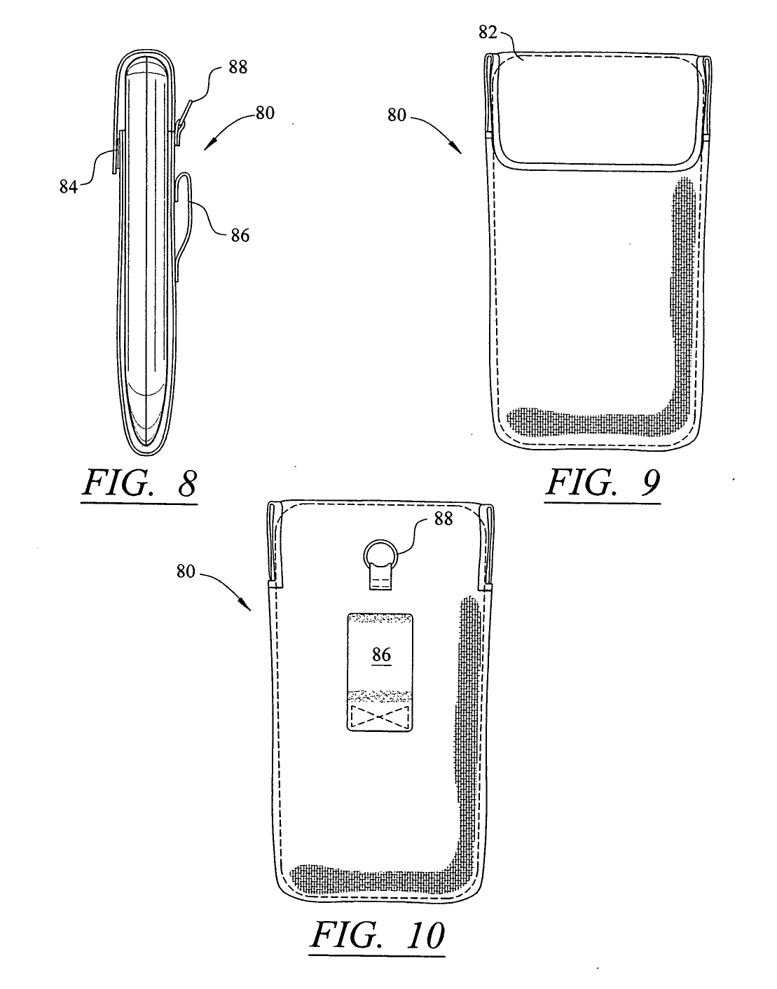

A holster 80 is provided for carrying the erasable note pad 10 on one's person. The holster may be formed of any suitable material, such as ballistic nylon, leather, canvas or the like, and includes a flap 82 for covering the top opening of the holster 80. Hook and loop fasteners or snaps 84 are provided for securing the flap closed over the opening. The erasable note pad device 10 is received through the top opening of the holster 80 and is contained therein, as seen in FIGS. 8-10. The holster includes a belt loop 86 for carrying the holster 80 and the erasable note pad device 10 on a waist belt. The holster 80 further includes a lanyard ring 88 for attachment of a chain, cord or the like. The opposite end of the lanyard may be secured to one's belt loop or, alternatively, to a purse or brief case to prevent loss of the holster and note pad device 10 contained therein.

As seen throughout the several views of the drawings, the casing 12 is formed and configured to provide a sleek and compact design which allows the device 10 to be conveniently carried in one's pocket (shirt or pants), purse or brief case. As seen in the drawings, the side edges, bottom and top of both the bottom cover 20 and top cover 30 are tapered to eliminate sharp edges and abrupt surfaces, thereby promoting smooth passage into and out of one's pocket while also eliminating unnecessary volume and bulk. The ability to conveniently carry the device in one's pocket provides the user with a means to readily record information (writing, illustrative sketches, etc.) that is of a necessary but temporary nature. The casing 12 protects and preserves the information against inadvertent erasure or loss, while allowing for convenient transport for subsequent reference. The erasable note pad 10 further provides for a simple method of disposing of information when it is no longer needed. The erasable note pad 10 eliminates the need to carry multiple pieces of paper and writing implements when in the field of occupation, traveling or during one's daily affairs.

In a preferred embodiment, the casing 12 is formed of a molded plastic composition. Further, the grasping members 62, pocket 70 and groove 38 are integrally molded as a single unit with the top case cover 30. Also, the bottom case cover 20 is integrally molded to include the rail 28 and slot 56. The locking clasps 48, 49 may further be integrally molded with the respective bottom and top case covers 20, 30. Further, the bottom case cover 20, top case cover 30 and dual fold hinge 40 may be formed as separate pieces or, alternatively, integrally molded as a single unit. Naturally, the case may be provided in any of a variety of colors with various designs or logos (e.g. corporate, professional team sports or college sports) appearing thereon.

While the invention has been shown and described in accordance with a preferred and practical embodiment thereof, it is recognized that departures from the instant disclosure are contemplated within the spirit and scope of the present invention as defined in the following claims and interpreted under the Doctrine of Equivalents.

What is claimed is:

1. A memo device, comprising:
a protective casing including a top cover and a bottom cover, said top and bottom covers each having an outer side and an inner side, and said top and bottom covers being hinged together to allow movement of said top cover relative to said bottom cover between a closed position wherein said inner sides are disposed in confronting relation to one another and concealed within said casing, and a fully open position wherein said inner sides of said top and bottom covers are exposed and accessible;
an erasable writing surface on said inner side of said bottom cover said erasable writing surface being adapted for writing thereon with an erasable ink marker pen; and
a securing structure on said inner side of said top cover for holding at least one erasable ink marker pen and an eraser for removing ink from said writing surface.

2. The memo device as recited in claim 1 further comprising cooperating clasp elements on said top and bottom covers for releasably interlocking said top and bottom covers in said closed position.

3. The memo device as recited in claim 2 wherein said erasable writing surface is on a sheet substrate fitted to said inner side of said bottom cover.

4. The memo device as recited in claim 3 wherein said securing structure includes at least one grasping structure for releasably holding said erasable ink marker pen.

5. The memo device as recited in claim 4 further comprising a plurality of said grasping structures for holding a plurality of said erasable ink marker pens.

6. The memo device as recited in claim 1 wherein said securing structure includes a pocket for holding said eraser.

7. The memo device as recited in claim 1 further comprising:
a rail formed about a periphery of said inner side of said bottom cover in surrounding relation to said writing surface; and
a groove formed about said periphery of said inner side of said top cover and being positioned and arranged for congruent mating receipt of said rail therein when said top and bottom covers are in said closed position.

8. The memo device as recited in claim 1 further comprising at least one hinge member hingedly interconnecting said top and bottom covers, and said at least one hinge member being structured and disposed for permitting hinged movement of said top cover relative to said bottom cover through an arc of rotation which positions said outer side of said top cover against said outer side of said bottom cover, and thereby defining said fully open position.

9. The memo device as recited in claim 1 further comprising a holster for holding said casing therein.

10. The memo device as recited in claim 9 wherein said holster includes a loop for securing and carrying said holster, and said casing therein, on a waist belt.

11. The memo device as recited in claim 9 wherein said holster includes a ring for attachment of a lanyard thereto.

12. The memo device as recited in claim 1 wherein said outer sides of said top and bottom covers are tapered in dimension about their periphery to promote ease of insertion and removal of the memo device within a clothing pocket.

13. The memo device as recited in claim 1 wherein said inner side of said bottom cover is provided with measurement gradient markings thereon.

14. A memo device, comprising:
a protective casing including a top cover and a bottom cover, said top and bottom covers each having an outer side and an inner side, and said top and bottom covers being hinged together to allow movement of said top cover relative to said bottom cover between a closed position wherein said inner sides are disposed in confronting relation to one another and concealed within said casing, and a fully open position wherein said inner sides of said top and bottom covers are exposed and accessible;
at least one hinge member hingedly interconnecting said top and bottom covers;
cooperating clasp elements on said top and bottom covers for releasably interconnecting said top and bottom covers in said closed position;
a sheet substrate fitted to said inner side of said bottom cover and including an exposed erasable writing surface adapted for writing thereon with an erasable ink marker pen;
at least one grasping structure on said inner side of said top cover for releasably holding an erasable ink marker pen; and
a holder on said inner side of said top cover for releasably holding an eraser, said eraser being adapted for removing ink from said writing surface.

15. A memo device as recited in claim 14 further comprising:
a rail formed about a periphery of said inner side of said bottom cover in surrounding relation to said writing surface; and
a groove formed about said periphery of said inner side of said top cover and being positioned and arranged for congruent mating receipt of said rail therein when said top and bottom covers are in said closed position.

16. The memo device as recited in claim 14 wherein said at least one hinge member is structured for permitting hinged movement of said top cover relative to said bottom cover through an arc of rotation which positions said outer side of said top cover against said outer side of said bottom cover, and thereby defining said fully open position.

17. The memo device as recited in claim 14 further comprising a holster for holding said casing therein.

18. The memo device as recited in claim 17 wherein said holster includes a loop for securing and carrying said holster, and said casing therein, on a waist belt.

19. The memo device as recited in claim 17 wherein said holster includes a ring for attaching a lanyard thereto.
